(19) United States
(12) Patent Application Publication
(10) Pub. No.: US 2021/0406799 A1
(43) Pub. Date: Dec. 30, 2021

(54) ANALYTICAL TECHNIQUES FOR FORECASTING FUTURE REGULATORY REQUIREMENTS

(71) Applicant: CarriRaj LLC, Radnor, PA (US)

(72) Inventors: Christopher Michael Carrigan, Radnor, PA (US); Girisha Chandraraj, Wilmette, IL (US)

(21) Appl. No.: 17/357,875

(22) Filed: Jun. 24, 2021

Related U.S. Application Data
(60) Provisional application No. 63/043,955, filed on Jun. 25, 2020.

(51) Int. Cl. G06Q 10/06; G06Q 30/00; G06F 16/2458; G06F 16/2455

(52) U.S. Cl. CPC G06Q 10/06375; G06Q 10/06315; G06F 16/24564; G06F 16/2462; G06Q 30/018

(57) ABSTRACT

The disclosed technology provides easy-to-access information on proposed and promulgated rules which includes data-driven probability-based predictions about whether regulations being considered will be promulgated as well as whether rules currently in force will be changed or removed within various timeframes in the future. As a result, the disclosed technology enables regulated firms to plan more effectively by providing greater clarity with respect to the regulatory environment they will face in the future.

### CROSS-REFERENCE TO RELATED APPLICATIONS

This application claims priority to Provisional Patent Application No. 63/043,955, filed Jun. 25, 2020, the entire contents of which are incorporated herein by reference.

### BACKGROUND

Relative to statutes, the large majority of the requirements imposed by governments on businesses and other organizations originate in government rules, alternatively known as regulations. To conduct their operations lawfully, organizations must conform to the regulations that apply to their industries and the markets in which they participate. Regulations touch almost all aspects of business operations, including ensuring that facilities emphasize workplace safety, consider environmental effects of their processes and products, and interact with each other according to certain principles that promote competition.

Regulations affect all types of businesses, ranging from large to small and from those that sell physical products to those that provide services. Through the requirements they impose, regulations influence the operations of these entities that are their targets in a variety of important ways. To attempt to achieve social goals, government agencies may write and enforce rules that mandate that organizations utilize certain technologies to reduce unwanted production byproducts, limit emissions to specified levels, plan in order to manage the risks of their operations, or disclose publicly information about their processes or products.

To appropriately manage these requirements, regulated entities need to be aware they exist, understand their content, and implement the required steps to comply. While the costs associated with implementing technologies and processes to conform directly with regulatory requirements are substantial, the prospect that additional—or different—requirements may affect their operations in the future represents an equally, if not more important, cost of conducting business for firms. The possibilities that new regulatory requirements may be imposed, changes may be made to existing regulations, or certain rules may be withdrawn introduces uncertainty for regulated businesses.

This uncertainty can impede organizations' abilities to forecast their operational and capital needs. Not knowing if an important regulation may be promulgated soon, in the distant future, or potentially not at all makes it difficult for a regulated organization's decision-makers to make thoughtful decisions affecting all aspects of the business, ranging from appropriately pricing existing products to forecasting their cost structure to deciding where to produce and sell their output. Beyond introducing possibilities for errors as business plans are formed based on little information or inaccurate information, uncertainty about the future regulatory environment may also persuade organizations to delay investing in otherwise profitable opportunities that can create social and economic value.

### BRIEF DESCRIPTION OF THE DRAWINGS

FIG. 1 is a flow diagram illustrating a general process used in some embodiments of the disclosed technology to make data-driven forecasts and other information available about regulations to the end user.

FIG. 2 is a flow diagram that depicts how regulatory forecasts are generated in some embodiments of the disclosed technology.

FIG. 3 is a block diagram that provides an illustration of the types of information available to the end user in some embodiments of the disclosed technology.

FIG. 4 is a block diagram that describes some options available to the end user in requesting information in some embodiments of the disclosed regulatory forecasting tool.

FIG. 5 is a flow diagram demonstrating how, in some embodiments, the disclosed technology draws from its database of regulatory predictions to provide specific information requested by the end user.

FIG. 6 is a flow diagram that provides one specific example of how the disclosed technology operates to respond to a specific request by the end user.

FIG. 7 is a flow diagram that provides one specific example of how the disclosed technology operates to estimate a likelihood of an action being performed for a rule.

FIG. 8 is a block diagram that illustrates an example of a computer system 800 in which at least some operations described herein can be implemented.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Various examples of the technology will now be described. The following description provides certain specific details for a thorough understanding and enabling description of these examples. One skilled in the relevant technology will understand, however, that the technology may be practiced without many of these details. Likewise, one skilled in the relevant technology will also understand that the technology may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the technology. Indeed, certain terms may even be emphasized below; however, any terminology intended to be interpreted in any restricted manner will be overtly and specifically defined as such in this Detailed Description section.

As described in the Background section, decision-makers working in businesses in regulated industries must both keep apprised of the latest regulatory requirements to adequately manage their obligations as well as accurately predict future regulatory burdens in making decisions that can affect all aspects of their operations, from investment to product development to marketing. Relative to the existing stock of regulations, it is often the uncertainty surrounding future regulatory requirements that proves to be most disruptive to companies, inhibiting them from developing effective business plans and efficiently allocating resources.

At any point in time, government regulators are considering a multitude of rules that could affect various aspects of a business' operations. As a result, keeping track of the possible rules at various stages along with the likelihoods these rules will ultimately affect a regulated organization's operations in the future is extremely difficult. Moreover, determining whether and when particular proposed regulations will be promulgated is a function of a myriad of factors, such that the “regulatory pipeline” becomes that much harder for a firm to anticipate.

The disclosed technology helps solve this problem for businesses by providing easy-to-access information on proposed and promulgated rules which includes data-driven probability-based predictions about whether regulations being considered will be promulgated as well as whether rules currently in force will be changed or removed within various timeframes in the future. As a result, the disclosed technology enables regulated firms to plan more effectively by providing greater clarity with respect to the regulatory environment they will face in the future.

The described technology improves upon the functioning of a computer by increasing the accuracy of a prediction. The described technology selects the most accurate statistical model to analyze various inputs and provide an output to the user wishing to determine if and when a rule will be promulgated. In addition, the described technology reduces the consumption of CPU cycles because the most accurate statistical model is selected and used for prediction, as opposed to using multiple statistical models and averaging their outputs. Using multiple statistical models to make the prediction consumes more CPU cycles than using a single statistical model.

Such a technology that makes predictions readily accessible by considering the factors that affect the likelihood and timing of potential new rules, potential changes to existing rules, and the possible withdrawal of current rules has not been developed in this manner. The disclosed technology combines expert understanding of the regulatory environment to incorporate factors that will affect future regulatory requirements coupled with an in-depth knowledge of computational modeling approaches to provide expert rule forecasts. Several implementations of the described technology are discussed below in more detail in reference to the figures.

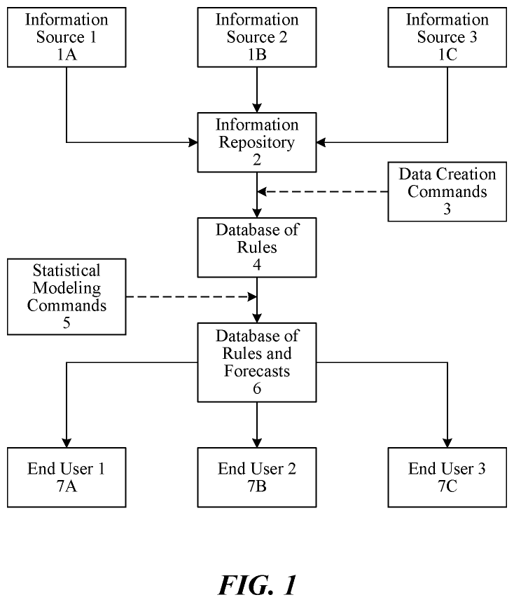

As reflected in FIG. 1, the disclosed technology captures raw information from government and other sources as shown in 1A, 1B, and 1C on rules at various stages of development. Examples of information sources include the U.S. Federal Register and Unified Agenda of Regulatory and Deregulatory Actions, state bulletins and registers, and foreign government publications such as the Canada Gazette. This information is transformed through the disclosed technology into easy-to-access data on proposed and existing rules, including probability-based predictions regarding the likelihood that those rules will be promulgated, removed, or changed at various points in time in the future.

The information acquired from the information sources 1A, 1B, and 1C is incorporated into a central repository 2 containing existing and proposed regulations that spans policy areas including environmental protection, labor, health, and finance and that dates back over 20 years in many cases. The repository thus includes information on regulations that have been promulgated both recently and in the more distant past. Through data programming commands 3, the disclosed technology transforms the information received into data that can be used as inputs into the statistical models. These data describing various features of the rules are captured in the database of rules 4 which includes those that, in some embodiments, can help inform predictions regarding whether regulations not yet promulgated might be in the future and whether as well as when regulations already promulgated might be eliminated or changed.

FIG. 1 illustrates that the disclosed technology can use these data which have been transformed from the information gathered from public sources and describe characteristics of regulations that have and have not been promulgated as inputs in technical statistical modeling approaches, including but not limited to survival analysis. The statistical modeling commands 5 developed in the disclosed technology can employ these modeling approaches to derive predictions about the rules that are not promulgated but are being considered by government agencies as well as existing regulations that may be withdrawn or changed in the future.

The associated probabilities are housed in the database of rules and forecasts 6 and are updated periodically. This is accomplished through statistical models operating in the background that utilize the aforementioned data from the database of rules 4 to compute the relevant probabilities for those not yet completed as well as for those that could be withdrawn or changed. For example, in one embodiment, new information from government sources is incorporated into the modeling process each day, which is then used to generate updated predictions.

As 7A, 7B, and 7C in FIG. 1 suggest, the end users can view portions of the database through a web-based interface, which allows that individual access to information about proposed and finalized rules in those areas associated with the user's subscription. In other implementations, the end users can view portions of the database using a graphical user interface generated by a web page, a graphical user interface generated by a software application, a window generated by a software application or a web page, a new tab in a web browser, a voice interface, a virtual spreadsheet sent via email, or another appropriate user interface. In some embodiments, the user is offered a variety of criteria upon which to select the rules to examine from the database. In addition to offering access to a central repository of existing regulations with probabilities that those regulations are withdrawn or changed in the future, the disclosed technology also provides information on rules proposed by agencies but not yet finalized, including estimating the probabilities these proposed obligations will become real requirements in the future.

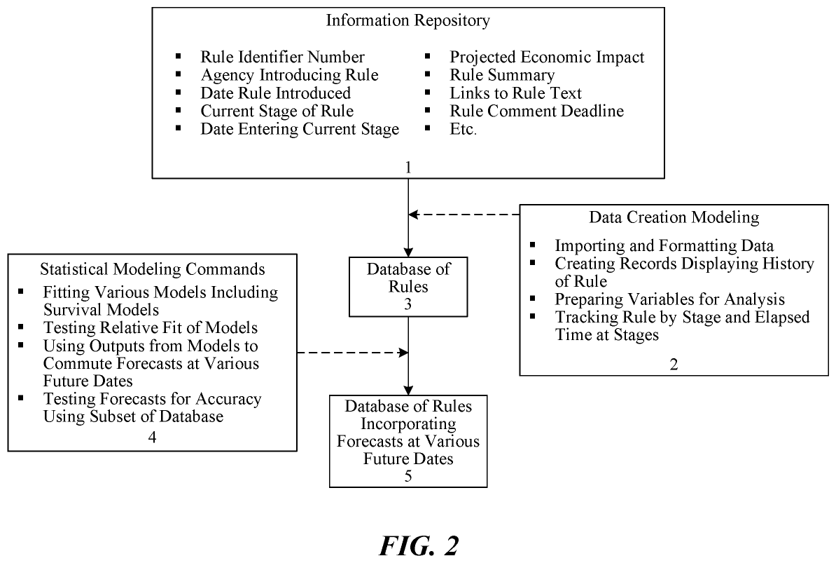

FIG. 2 offers a more specific look at one aspect of how the disclosed technology functions in some embodiments, namely how regulatory forecasts are produced. The figure shows a subset of the types of data that are both provided to the end user as well as used to make forecasts about proposed as well as existing regulations.

Among other elements, the information repository 1 can contain, for existing regulations as well as regulations being considered, a unique number assigned to each rule; the government agency responsible for that regulation; a summary of the requirement; the dates in which it was initiated and, where relevant, finalized and became effective; the current stage in the regulation's development; a link to its full text, the regulation's projected impact on the economy as determined by any combination of the promulgating agency, the U.S. Office of Management and Budget, a state or local government organization, an international governing body, and/or another authority; and, when relevant, upcoming public comment deadlines and hearing dates.

The sources for this information include, but are not limited to, the Federal Register, which is the daily journal of the U.S. government; the Unified Agenda of Regulatory and Deregulatory Actions, which is typically released by the Regulatory Information Service Center and the Office of Information and Regulatory Affairs on a semiannual basis and tracks information on U.S. federal government regulatory and deregulatory activities at various stages of development; state and local government periodicals which contain information on proposed and finalized regulations such as the California Regulatory Notice Register and the Pennsylvania Bulletin; and publications of foreign governments, such as the Canada Gazette and Mexico's Official Journal of the Federation, where the public is notified of rules in process as well as those that have been promulgated.

The aforementioned information acquired from these various sources and others can then be used to generate data that can be fed into the models employed to generate forecasts. Computer programs associated with the disclosed technology, as described in FIG. 2 through data creation modeling 2, are used to import and format information collected on the rules in preparation for statistical analysis. These programs can also be utilized to create variables that in some embodiments represent a complete history of the rules for use in analysis. The variables include, but are not limited to, individual observations tracking each of the stages in which rules have resided or currently reside as well as variables measuring tabulations of the time elapsed at various rulemaking stages.

Other variables created through the programming commands and housed in the database of rules 3 can include indicators categorizing the importance of the rule as determined by the agency promulgating it and other government entities; the specific stage where the rule resided during the particular timeframe in question; the specific stage the rule occupied at the end of the timeframe in question; the specific agency or agencies responsible for the rule at those stages from among the universe of possibilities represented in the data; and the date in which the rule was initiated from among the possibilities represented in the database.

As highlighted in statistical modeling commands 4 in FIG. 2, the modeling approach employed by the disclosed technology uses the aforementioned variable inputs, as well as others, from existing regulations and, in some embodiments, parametric survival model methods to generate outputs in the form of regulatory predictions for the user. While other approaches may also be appropriate for predicting regulatory outcomes and can be incorporated in some embodiments of the disclosed technology, survival modeling methods, despite being initially used to study and predict human mortality, offer useful attributes that make them well positioned to provide regulatory forecasts, especially relative to other methods such as conventional regression approaches, including, but not limited to, linear regression and probit and logit regression.

Among these features, survival modeling approaches, as they are employed in the disclosed technology, are able to incorporate any changes in the characteristics of a rule over time to allow for more precise and accurate predictions. For example, as the stage in the rulemaking process or the associated political environment in which a rule resides shifts, this updated information can be used to help in forecasting when that rule and others are likely to be promulgated, changed, or withdrawn. By contrast, conventional regression modeling approaches would treat the characteristics that can help explain the likelihood a rule will be promulgated, amended, or withdrawn as time-invariant, meaning that they do not change over time.

Further, parametric survival modeling approaches are more appropriate for modeling the time elapsed to an event like the promulgation of a rule, which is positive by definition and generally characterized by a distribution that exhibits substantial asymmetry. In contrast, in generating forecasts and associated confidence bounds using a linear regression model, for example, the regression errors, which represents the portion of time elapsed not explained by the model, are assumed to be normally distributed, which is less reasonable when modeling the time until a rule is finalized, changed, or withdrawn. Effectively, employing parametric survival modeling techniques allows the disclosed technology to make more appropriate distributional assumptions about the model's errors, given the fact that rulemaking time is the variable being explained.

In addition, by employing parametric survival models, the disclosed technology can be performed using not only those rules that have been promulgated or changed and those that have been withdrawn, but also those that are being considered but have not been promulgated. Sometimes referred to as right censored observations, including the latter group of rules allows the technology to generate more accurate forecasts, both because the forecasts incorporate more information and because they avoid any bias associated with excluding certain classes of rules from the data used to generate the predictions. In contrast, modeling the length of time to promulgate, amend, or withdraw rules based on rule characteristics using a conventional linear regression model means eliminating from the estimation process those rules that have not reached the state of interest. Similarly, choosing to model whether or not a rule has been promulgated, amended, or withdrawn using a conventional probit or logit regression model in an effort to include the censored observations simultaneously eliminates from the analysis the time elapsed that the rule has been under consideration as well as the possibility to predict when a rule might be promulgated, withdrawn, or changed, unlike parametric survival modeling approaches. By employing survival modeling approaches, the disclosed technology considers more rules and more information about those rules to allow the technology to produce more accurate and unbiased predictions regarding the timing of when regulations are likely to be promulgated, altered, or withdrawn.

To develop the coefficient estimates that form the basis for making the forecasts for rules being considered but not yet promulgated as well as rules already promulgated that could be revised or withdrawn, the disclosed technology fits various parametric survival models, as well as other types of models, to the database of rules 3 in FIG. 2. What this means is that the variables collected and created through the disclosed technology—including characteristics of the rules in the database such as the stage in which the rule resides, the agency or agencies that introduced the rule, the date that the rule was introduced, the expected economic impact of the rule, and whether the rule has been promulgated, among others—are used to estimate the impacts of these various characteristics on the likelihood that the rule is promulgated, withdrawn, or changed, given that the database of rules also includes information on each rule's current and historical status with respect to whether or not it has been promulgated, withdrawn and changed. Different characteristics will have differing impacts on the likelihood a rule is promulgated, changed, or withdrawn, with respect to both the degree to which they affect the outcome of interest as well as in which direction.

As suggested in statistical modeling commands 4 in FIG. 2, the disclosed technology fits to the data a variety of models, including a range of parametric survival models, that incorporate various assumptions. Relative to non-parametric and semi-parametric survival models, parametric models offer the advantage that they can more easily be used to make predictions, here more specifically about whether and when regulations will be promulgated, changed, or withdrawn. The modeling approaches incorporated through the disclosed technology differ primarily with respect to the assumptions they make about how the hazard rate associated with whether rules are promulgated, revised, or withdrawn changes over time. With respect to the disclosed technology, the hazard rate represents the rate at which rules are promulgated, revised, or withdrawn at a particular point in time given that they reached that point in time without the event of interest happening.

Different parametric survival models make different assumptions about how the hazard rate changes as the length of time that the rule does not reach the event of interest, including being promulgated, revised, or withdrawn, increases. For example, a Weibull model assumes that the hazard rate changes in one direction over time, either consistently increasing or consistently decreasing, or stays the same. In contrast, a log-logistic model, for instance, allows the hazard rate to change in different directions over time. Additional parameters, sometimes called shape and scale parameters, that are fit based on the database of rules determine how much the hazard rate changes in particular directions over time.

As indicated in statistical modeling commands 4 in FIG. 2, these various models that the disclosed technology applies are then compared through statistical tests to identify the approaches that best fit the data at the time the models are run, recognizing that the technology allows for the possibility that alternative approaches may be better at different times depending on the context. Further, in some embodiments, a range of predictions regarding the likelihoods at different points in time that rules in process are promulgated and those already promulgated are withdrawn or changed are provided based on the differing predictions of the various models that are fit to the data.

The tests that are employed to compare the models are statistical measures that assess how well each of the models describes the database of rules 3 in FIG. 2, which can then be compared with each other. Each model has one or more parameters that describe probability distributions that the event of interest will occur over time. Many of the parametric survival models employed through the disclosed technology are computed through a statistical technique called maximum likelihood estimation, whereby the values of the parameters are determined within the framework of the particular model based on choosing those values that make it most likely that the chosen model describes process by which the database of rules 3 was created. The Akaike information criterion, as employed in the disclosed technology for example, uses the log-likelihood values for these models created through the estimation processes of the disclosed technology while simultaneously considering the number of parameters and variables used to compare the models as a way to determine which best fits the database of rules 3 at the point at which the models are run. Other techniques incorporated into the disclosed technology for adjudicating between the models used to make regulatory forecasts include, but are not limited to, the Bayesian information criterion as well as Wald and likelihood-ratio tests to compare parametric survival models that can be nested within others like the Weibull model can be within the generalized gamma model.

The statistical modeling commands 4 illustrate that the chosen modeling approaches as well as the associated coefficient estimates can then be employed to make predictions regarding if and when rules not yet promulgated might be promulgated as well as if and when rules already promulgated could be modified or withdrawn. A processor executing instructions programmed into the statistical software associated with the enclosed technology can make predictions including computing probabilities that rules are promulgated or withdrawn within various timeframes including, but not limited to, three months, six months, one year, two years, and five years. As the statistical modeling commands 4 in FIG. 2 further suggest, in some embodiments, these forecasts are then tested to assess their accuracy using a subset of rules that have been held from the database of rules used to calibrate the models. The accuracy of these predictions can then be examined using these test rules before the updated forecasts are added to the database of rules as illustrated in the database of rules incorporating forecasts at various future dates 5 in FIG. 2.

As one illustration of the testing process, in some implementations, the choice among modeling approaches can be made by “back-testing” the models, or by defining known input variables up to a point in history and using the chosen modeling approaches to predict what should have happened at that point in history regarding promulgation of the rule based on the known factors. The resulting output from the chosen modeling approaches can then be compared to a known action associated with the rule (e.g., if the rule was actually promulgated or not in history) to determine if the chosen modeling approaches predicted that outcome with a high likelihood. The chosen modeling approaches can then be further refined using this comparison, such as updating the chosen modeling approaches if the predicted outcome was not accurate or reaffirming the chosen modeling approaches if the predicted outcome was consistent with the actual outcome.

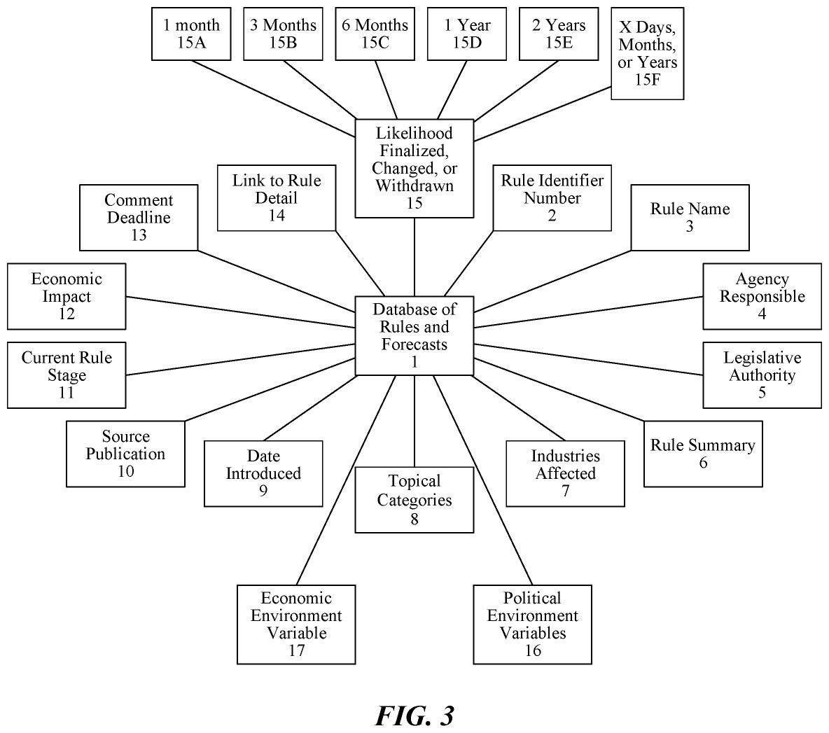

Those skilled in the art will appreciate that the components illustrated in FIGS. 1 and 2 described above, and in each of the FIGS. 3 through 8 discussed below, may be altered in a variety of ways. For example, the order of the logic may be rearranged, substeps may be performed in parallel, illustrated logic may be omitted, other logic may be included, etc.

The disclosed technology can be operational with numerous general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 3 offers one example of the information that the disclosed technology can provide to the end user in any of the aforementioned computing system environments or others. The figure illustrates that, in some embodiments, the information housed in the database of rules and associated forecasts 1 that can be accessed by the end user can include: an identifier number 2 such as the regulation identifier number assigned by the Regulatory Information Service Center in the U.S. federal government; the name of the rule 3; the agency or agencies responsible for it 4; the legislative authority for the rule 5; a summary of the rule 6; the industries that the rule affects 7; the topical and/or policy categories it addresses 8; when it was first introduced 9 and in what publication 10; its stage in the rulemaking process 11; its projected economic impact 12 as determined by the agency and/or another government body such as the U.S. Office of Management and Budget; any important dates listed for the rule which may include scheduled hearings focused on it and/or deadlines for agency receipt of public comments 13; and a link to the most current notice describing the details of the rule 14 in a publication like the U.S. Federal Register or the Pennsylvania Bulletin.

As described by 15 in FIG. 3, the end user can also, through the chosen computing system environment, retrieve estimates of the likelihoods that the rule or rules viewed are finalized at various milestone dates if they are still in process. Alternatively, if the viewed rule is already finalized, the end user can review estimates that the rule is withdrawn or changed at various milestone dates. In some applications, the milestone dates could include one month 15A, three months 15B, six months 15C, one year 15D, and two years 15E, in addition to other possibilities 15F. These can be chosen by the end user contingent on the planning timeframe being considered.

Other information that can be used in determining estimates of the likelihoods can include political environment variables 16 and economic environment variables 17. Political environment variables 16 can include such inputs such as which political party holds a position of power in the associated government, polling data showing favorability ratings of particular political parties or politicians, and the like. Economic environment variables 17 can include variables such as gross domestic product from the last fiscal year, current federal interest rates, gross domestic product growth rate, inflation rates, and the like.

In some implementations, the end user can also select various assumptions to be used as variables in determining the estimates of the likelihoods that the rule or rules viewed are finalized at the various milestone dates. For example, the end user can manually input particular assumptions about various factors used in determining the estimates or particular assumptions can be automatically input from external sources, such as polling sites, published expert opinions, and the like. These assumptions can be used to model various scenarios from which the estimates of the likelihoods can be obtained.

The assumptions can be variables that are taken into account by the models to estimate the likelihoods. In a non-limiting example, the assumptions can include an assumption of a political office being filled by a candidate by a particular party, a particular other regulation being passed, a change in leadership at a particular agency or lobbying group, and the like. These assumptions can be input into the models as variables, which are then processed by the models to estimate the likelihoods associated with various outcomes based on the assumptions and other data as described herein.

In some implementations, the assumptions can include a time frame for the assumption. In a non-limiting example, an assumption can be made that a particular leader at an agency will be replaced in three months, which may lead to a different estimation of a likelihood for a particular action regarding a regulation than the leader of the agency being replaced in six months or a year.

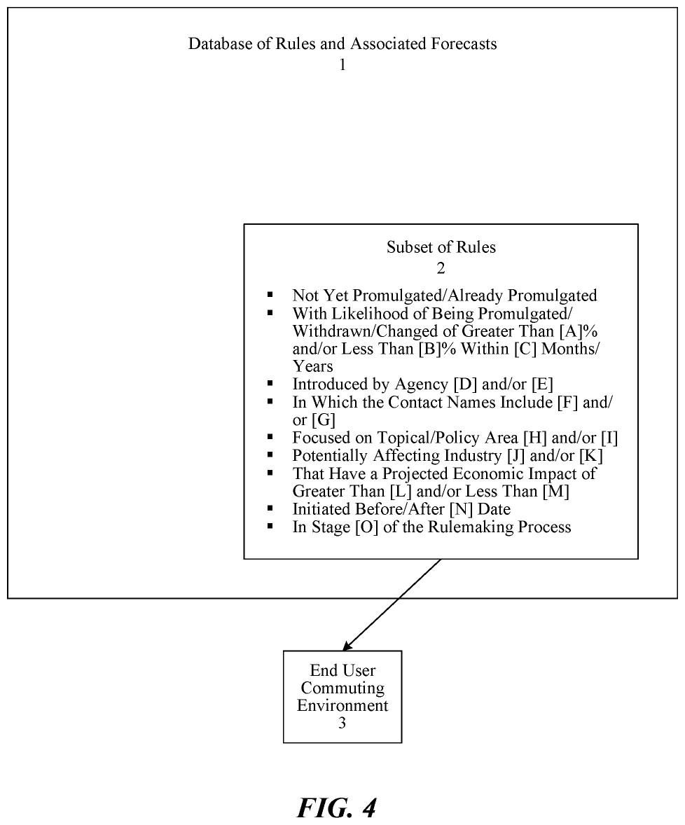

FIG. 4 extends FIG. 3 to show some of the options available to the end user to draw from the database of rules and forecasts 1 in some embodiments of the disclosed technology. The user can request information through a variety of input devices which could include, for example, a mouse, a keyboard, a touchscreen, an infrared sensor, a touchpad, a wearable input device, a camera- or image-based input device, a microphone, or other user input device. Using the preferred input device, end users can request specific information about a subset of regulations that have particular relevance to them.

In some embodiments, the user can choose to view a subset of the regulations in the database along various dimensions. Among other possibilities, these dimensions, as described in the subset of rules 2 in FIG. 4, include: whether or not the rule has been promulgated; the forecasted likelihood a proposed rule will be promulgated at different points in time as chosen by the user; the forecasted likelihood a current rule will be withdrawn or changed at various points in time as chosen by the user; the agency or agencies that initiated the rule; the agency personnel serving as contacts for the rule; the particular policy or topical area that the rule concerns; the industries that the rule affects; the forecasted economic impact of the rule; whether the rule was initiated before or after a certain date; and the current stage in the regulatory process in which the rule resides.

As one example, an end user might be interested in viewing the set of proposed regulations that both have a likelihood of at least 50 percent of being promulgated in the next year and could affect the specific industry in which the user works. After making this request through the user's interface with the disclosed technology, as FIG. 4 illustrates, the set of regulations are provided, in some embodiments, in a list in that user's computing environment 3.

In addition, as further described in FIG. 3, the disclosed technology can allow the user to request specific information about each of the rules. The aforementioned user, for example, could request information through their input device about the agency or agencies that introduced each of the rules, the topical or policy areas that each of the rules addresses, the projected economic impact of each rule, and probabilities that each rule will be promulgated at other points in time in addition to the specific forecast criteria that the user specified. In this case, the disclosed technology would supply the rules that meet the parameters chosen by the end user as well as the requested information about each of those rules as described.

In some implementations, in addition to determining if rules will be promulgated, the models can determine likelihoods that existing rules will be changed, existing rules will be revoked, proposed rules will be withdrawn, or particular rules or dimensions of rules will be proposed formally through an official notice. In a non-limiting example, using the same models or similar models to the described models, with the same or similar input data, estimations of likelihoods of other actions being taken for rules or regulations, such as revocation of an existing rule or withdrawal of a rule under consideration, can be determined. In some implementations, additional data can be used to make these estimations. In a non-limiting example, based on data regarding a particular agency, the models can estimate a likelihood that a rule may be proposed through a notice in the Federal Register or another publication of the associated government, be publicized in an advance notice, and the like.

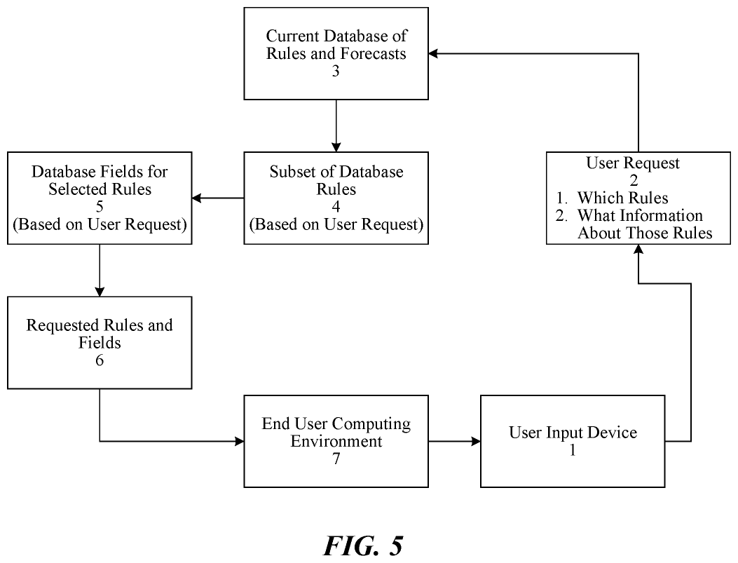

Building from FIG. 4, FIG. 5 illustrates the process by which the disclosed technology retrieves and provides the specific information requested by the end user. In some embodiments, the end user employs their input device 1 to request to view specific categories of rules as shown in 2, including, for example, those in process that have a particular level of certainty of being promulgated or those already promulgated that have a particular likelihood of being removed or changed. The user can also request certain information about those rules as shown in 2, including for example, summaries of the associated rules and their forecasted economic impacts. The disclosed technology then draws the specific rules from the current database of rules and forecasts 3 that meet the criteria requested by the end user.

The database 3 associated with the disclosed technology that is culled to respond to the end user's request represents the most recent version of that database. In some embodiments, that database is updated on a daily basis, drawing from the aforementioned sources as well as others to incorporate new information including but not limited to new regulations in process, changes to existing regulations in process, and changes to regulations previously promulgated. This raw information is then transformed into usable data for modeling through, but not limited to, the aforementioned steps outlined in FIG. 2. In addition to incorporating new data into the database, the modeling approaches described are fit to the data and the aforementioned statistical tests and others are used to identify the approach or approaches that best characterize the updated dataset.

The chosen modeling approaches are then employed to form the predictions at various timeframes using the aforementioned computational methods. These predictions can be used to determine which regulations in process and promulgated in the past will be provided to the end user. In some embodiments, they can also be made available to the end user if that user requests additional forecasts beyond simply those that determine the criteria for selection.

As shown in the subset of database rules 4 in FIG. 5, the disclosed technology then retrieves, from the most current database, those regulations that fit the criteria chosen by the end user. The rules and associated information requested by the end user about those rules as illustrated in the database fields for selected rules 5, and described in detail in FIGS. 3 and 4, are delivered through the disclosed technology as shown in 6 to the end user in that user's computing system environment 7.

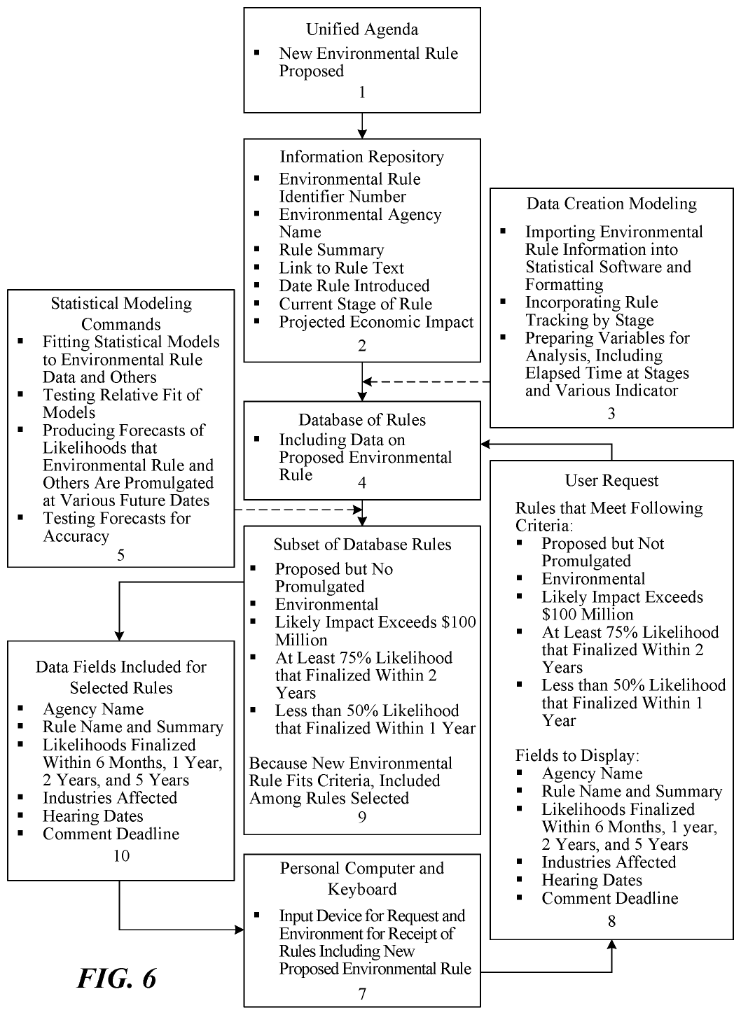

FIG. 6 provides a holistic view of the disclosed technology by offering one example of how information about a regulation that is being considered by a government entity may be incorporated by the disclosed technology to provide predictions about that regulation as well as others that can help the end user make more informed organizational and business decisions. The figure focuses on one example of a regulation not yet promulgated, but similar processes describe how the disclosed technology uses information about regulations in other states, including those already promulgated, to provide analogous expert forecasts for the end user.

FIG. 6 describes an example of a hypothetical regulation that has been proposed by an agency focused on environmental protection. In the particular case described, the environmental regulation 1 is first reported by the U.S. federal government in the Unified Agenda of Regulatory and Deregulatory Actions. At that point, information about the regulation—which could include but is not limited to the associated regulation identifier number, the name of the agency proposing it, a summary of the regulation, the full text of the proposed rule, the date it was first introduced, the stage in the rulemaking process in which the rule resides, and the projected economic impact of the rule—is captured by the disclosed technology in information repository 2.

As illustrated in data creation modeling 3, the aforementioned information about the proposed environmental rule is then transformed using a series of computer programming commands, and new observations and variables are created that can be used to generate predictions both about that rule and others that have been collected over time. As described, the information added to the database through this process includes, but is not limited to, observations tracking each stage in which the rule has resided and the time elapsed at each of these various stages as well as transformations of other information such as the environmental agency that introduced it and the expected economic impact of the sample proposed environmental rule to enable that information to be usable for the statistical modeling that follows. Effectively, this new information captures a full evolutionary history of the environmental rule and others in addition to adding other variables that can be used in the analysis, as culled from the information collected through the disclosed technology.

The data created for the environmental rule as well as others housed in the database 4 can then be submitted to additional computer programming commands, represented in 5. These commands call a variety of statistical models to be fit to the data as explained in detail in connection to the description of statistical modeling commands 4 in FIG. 2. The model or models chosen based on the aforementioned statistical criteria can then be used to form forecasts for the proposed environmental regulation as well as other rules in the database in various stages of the rulemaking process.

Statistical modeling commands 5 in FIG. 6 further demonstrates that the programs created as part of the disclosed technology can then be used to perform statistical tests to identify those modeling approaches that best fit the data, including the sample proposed environmental rule, at the time the programs are run. Computations executed through the associated programming commands can then be applied to the identified models and the associated outputs from those models to form predictions for the proposed environmental regulation as well as other regulations in the database associated with the disclosed technology. In some embodiments, the forecasts can include probabilities that the proposed environmental regulation described will be promulgated within a variety of timeframes, which may include the next three months, the next one year, the next two years, or the next five years, as well as a number of other possibilities. As described, these forecasts can then be tested for accuracy using a subset of the database. The probabilities along with the other data collected and created through the aforementioned computer programs are housed in the updated database 6.

FIG. 6 further describes how the end user might acquire information that includes the sample proposed environmental regulation. In the figure, the end user requests data about regulations using their personal computer and keyboard 7, which is one of a variety of computing environments and input devices that could be employed to perform this function. In the specific example highlighted in the figure, the end user requests information as shown in 8 on all regulations that: are proposed but not currently promulgated; involve environmental regulatory obligations; are likely to have an impact on the economy that exceeds $100 million; and have at least a 75 percent likelihood of being finalized in the next two years but less than a 50 percent likelihood of being finalized in the next one year.

In the example, the proposed environmental regulation described fits the aforementioned criteria. As a result, it is included among the rules that the disclosed technology provides the user for review. In the example provided, the user has selected to view in 8 not only the likelihoods that each of the rules will be finalized within one year and two years but also the likelihoods that the rules that meet the user's criteria for selection are promulgated within six months and five years. In addition, the user in the example described in FIG. 6 selects to view, for each rule, the agency or agencies that introduced it, the rule's name as given by that agency or agencies, a rule summary, any upcoming dates announced by the agency or agencies for the submission of comments or hearings connected to the rule, and the industries that the rule affects.

Using the criteria provided by the end user, the disclosed technology selects the relevant rules as displayed in the subset of database rules 9, which in this example includes the proposed environmental regulation, and feeds them to that user's personal computer 7. Although the data and analysis can be provided to the user in various formats, in some embodiments, the rules that meet the end user's criteria for selection are provided in a list form.

The end user can access the requested information described in database fields included 10 about each rule by selecting it. For example, using their keyboard 7 to select the hypothetical proposed environmental rule for closer inspection among all of the rules provided in response to the user's request, the user can examine the data provided, including the specific forecasts requested. As 10 suggests, in the particular request highlighted in FIG. 6, these data include the likelihoods that the proposed environmental rule is promulgated within six months, one year, two years, and five years.

Although the sample rule described in FIG. 6 is a proposed U.S. federal government environmental rule, the technology described in this application is equally applicable to making predictions about whether regulations in other contexts will be promulgated, withdrawn, or amended. Such environments might include rules created by governments and other organizations focused on different policy contexts, including but not limited to workplace safety, finance, and healthcare, and at different levels of government, including states, municipalities, and international bodies.

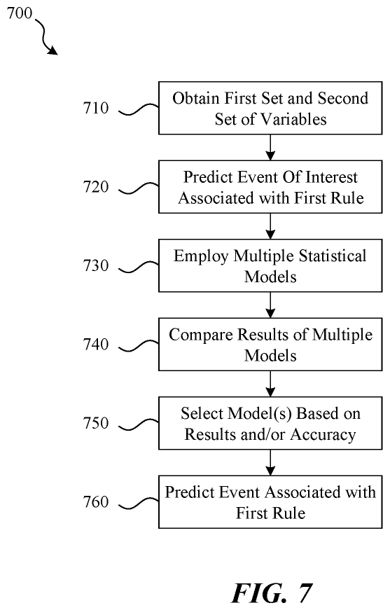

FIG. 7 illustrates a flow diagram 700 that provides one specific example of how the disclosed technology operates to estimate a likelihood of an action being performed for a rule. One or more statistical models can be trained using historical input data and a known outcome associated with the historical input data.

At block 710, a hardware or software processor executing the instructions described in this application obtains a first set of variables associated with a first rule and a second set of variables associated with a second rule. The first set of variables describes the first rule and the second set of variables describes the second rule. Each of the first and second set of variables include multiple stages of life of the associated rule and time elapsed at each stage of life for each respective rule.

At block 720, the processor can predict an event of interest associated with the first rule. For example, the first rule is predicted to be promulgated, withdrawn, cancelled, revised, or the like.

At block 730, to predict the event of interested associated with the first rule, the processor can employ multiple statistical models. Each of the statistical models is a different model from the other statistical models, but each statistical model receives the first set of variables and/or the second set of variables as input and predicts the likelihood of each type of event occurring at a future point in time. Each statistical model differs from other statistical models based on how a hazard rate associated with the predicted event changes over time, among other attributes. The hazard rate can be consistently increasing, consistently decreasing, staying the same over time, or increasing or decreasing non-monotonically over time. The hazard rate indicates the rate at which the rule is promulgated, revised or withdrawn at a particular point in time given that it reached that point in time without the event of interest occurring. One or more statistical models among the multiple statistical models can include a parametric survival model.

At block 740, the processor can compare the multiple statistical models using multiple tests. The multiple tests can evaluate the accuracy of the statistical models. In other words, the tests can evaluate how well the multiple statistical models and multiple parameters associated with the multiple statistical models describe the first and the second set of variables associated with the first and the second rules.

At block 750, the processor can select the model based on the results of the comparison. To select the appropriate statistical model, the processor can use the second set of multiple variables. The processor can separate the second set of multiple variables into a first subset and a second subset. The first subset associated can represent the inputs into the statistical model that are used for the first set of variables. The second subset can represent the output to be predicted for the first set of variables. The second subset can be historical data associated with the second set of variables. The processor can determine an accuracy of a statistical model by using the statistical model to predict an event of interest in the second subset based on the first subset. The processor can select a statistical model or models among the multiple statistical models fitting the data best and having the highest accuracy in predicting the stage of life in the second subset. The selected model can be used to predict the event of interest for the first set of variables.

At block 760, the processor, using the selected statistical model, can predict the event of interest associated with the first rule. In some implementations, the predicted event of interest can be output to a user via a display, in a file, or by audio to inform the user of the predicted event. The processor can use the same statistical model to predict the second event of interest. Alternatively, the processor can perform the same steps to select a different statistical model to predict the second event of interest.

The processor can also receive a user input defining an assumption for predicting the event of interest, as described in this application. The processor can predict the event of interest using the selected one or more statistical models based at least partly on the received assumption.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

Computer System

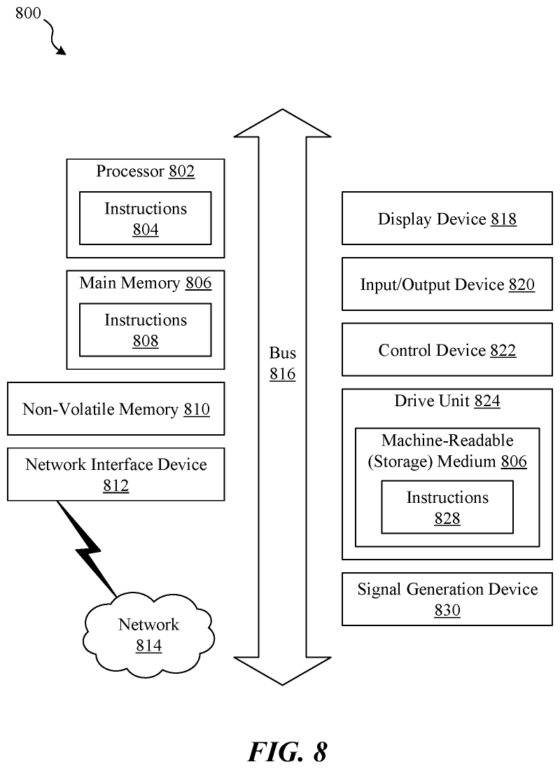

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, video display device 818, an input/output device 820, a control device 822 (e.g., keyboard and pointing device), a drive unit 824 that includes a storage medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementation, the computer system 800 can be an embedded computer system, a system-on-chip (SOC), a single-board computer system (SBC) or a distributed system such as a mesh of computer systems or include one or more cloud components in one or more networks. Where appropriate, one or more computer systems 800 can perform operations in real-time, near real-time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adaptor card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

We claim:

1. A method to predict events of interest associated with rules, the method comprising:
obtaining a first set of multiple variables describing a first rule and a second set of multiple variables describing a second rule,
wherein each of the first set of multiple variables and the second set of multiple variables include multiple stages of life associated with the first rule and the second rule, and time elapsed at each stage of life associated with the first rule and the second rule; and
predicting an event of interest associated with the first rule,
wherein the event of interest includes one or more of: a promulgation, a revision, or a withdrawal, by:
employing multiple statistical models that take the first set of multiple variables and the second set of multiple variables as input and predict a likelihood of the event of interest occurring at a future point in time associated with the first rule based on the first set of multiple variables,
wherein the multiple statistical models differ based on how a hazard rate associated with the event of interest changes over time,
wherein the hazard rate indicates a rate at which the first rule, the second rule, or both are promulgated, revised or withdrawn at a particular point in time given that it reached that point in time without the event of interest occurring;
comparing the multiple statistical models using multiple tests evaluating how well the multiple statistical models describe the first set of multiple variables associated with the first rule and the second set of multiple variables associated with the second rule;
selecting one or more statistical models among the multiple statistical models that best fits the second set of multiple variables; and
predicting the event of interest associated with the first rule using the selected one or more statistical models.

2. The method of claim 1, wherein predicting the event of interest associated with the first rule comprising:
separating the second set of multiple variables into a first subset and a second subset;
determining an accuracy of a statistical model among the multiple statistical models by using the statistical model to predict the event of interest in the second subset based on the first subset; and
selecting the one or more statistical models among the multiple statistical models having the highest accuracy in predicting the stage of life in the second subset.

3. The method of claim 1, wherein the one or more statistical models among the multiple statistical models comprises a parametric survival model.

4. The method of claim 1, wherein the hazard rate is consistently increasing, consistently decreasing, or staying the same over time.

5. The method of claim 1, wherein the hazard rate is increasing and decreasing over time.

6. The method of claim 1, comprising selecting one or more statistical models to predict a second event of interest.

7. The method of claim 1, comprising training at least one of the multiple statistical models using historical input data and a known outcome associated with the historical input data.

8. A computer-readable medium comprising instructions that, when executed by one or more processors, cause the one or more processors to execute a process, the process comprising:
obtaining a first set of multiple variables describing a first rule and a second set of multiple variables describing a second rule,
wherein each of the first set of multiple variables and the second set of multiple variables include multiple stages of life associated with the first rule and the second rule, and time elapsed at each stage of life associated with the first rule and the second rule; and
predicting an event of interest associated with the first rule, wherein the event of interest includes one or more of: a promulgation, a revision, or a withdrawal, by:
employing multiple statistical models that take the first set of multiple variables and the second set of multiple variables as input and predict a likelihood of the event of interest occurring at a future point in time associated with the first rule based on the first set of multiple variables;
comparing the multiple statistical models using multiple tests evaluating how well the multiple statistical models describe the first set of multiple variables associated with the first rule and the second set of multiple variables associated with the second rule;
selecting one or more statistical models among the multiple statistical models that best fits the second set of multiple variables; and
predicting the event of interest associated with the first rule using the selected one or more statistical models.

9. The computer-readable medium of claim 8, wherein one or more statistical models among the multiple statistical models comprises a parametric survival model.

10. The computer-readable medium of claim 8, wherein the multiple statistical models differ based on how a hazard rate associated with the event of interest changes over time among other attributes,
wherein the hazard rate indicates a rate at which a rule is promulgated, revised or withdrawn at a particular point in time given that it reached that point in time without the event of interest occurring,
wherein the hazard rate is consistently increasing, consistently decreasing, or staying the same over time.

11. The computer-readable medium of claim 8, the process further comprising selecting one or more statistical models to predict a second event of interest.

12. The computer-readable medium of claim 8, the process further comprising:
separating the second set of multiple variables into a first subset and a second subset;
determining an accuracy of a statistical model among the multiple statistical models by using the statistical model to predict the event of interest in the second subset based on the first subset; and
selecting the one or more statistical models among the multiple statistical models having the highest accuracy in predicting the stage of life in the second subset.

13. The computer-readable medium of claim 8, the process further comprising training at least one of the multiple statistical models using historical input data and a known outcome associated with the historical input data.

14. A computing system, comprising:
one or more processors; and
at least one memory comprising instructions that, when executed by the one or more processors, cause the one or more processors to execute a process, the process comprising:
obtaining a first set of multiple variables describing a first rule and a second set of multiple variables describing a second rule,
wherein each of the first set of multiple variables and the second set of multiple variables include multiple stages of life associated with the first rule and the second rule, and time elapsed at each stage of life associated with the first rule and the second rule; and
predicting an event of interest associated with the first rule, wherein the event of interest includes one or more of: a promulgation, a revision, or a withdrawal, by:
employing multiple statistical models that take the first set of multiple variables and the second set of multiple variables as input and predict a likelihood of the event of interest occurring at a future point in time associated with the first rule based on the first set of multiple variables,
wherein the multiple statistical models differ based on how a hazard rate associated with the event of interest changes over time,
wherein the hazard rate indicates a rate at which the first rule, the second rule, or both are promulgated, revised or withdrawn at a particular point in time given that it reached that point in time without the event of interest occurring;
comparing the multiple statistical models using multiple tests evaluating how well the multiple statistical models describe the first set of multiple variables associated with the first rule and the second set of multiple variables associated with the second rule;
selecting one or more statistical models among the multiple statistical models that best fits the second set of multiple variables; and
predicting the event of interest associated with the first rule using the selected one or more statistical models.

15. The computing system of claim 14, wherein one or more statistical models among the multiple statistical models comprises a parametric survival model.

16. The computing system of claim 14, wherein the hazard rate is consistently increasing, consistently decreasing, or staying the same over time.

17. The computing system of claim 14, the process further comprising selecting one or more statistical models to predict a second event of interest.

18. The computing system of claim 14, the process further comprising:
separating the second set of multiple variables into a first subset and a second subset;
determining an accuracy of a statistical model among the multiple statistical models by using the statistical model to predict the event of interest in the second subset based on the first subset; and
selecting the one or more statistical models among the multiple statistical models having the highest accuracy in predicting the stage of life in the second subset.

19. The computing system of claim 14, the process further comprising training at least one of the multiple statistical models using historical input data and a known outcome associated with the historical input data.

20. The computing system of claim 14, the process further comprising:
receiving a user input defining an assumption for predicting the event of interest; and
predicting the event of interest using the selected one or more statistical models based at least partly on the received assumption.
